(19) United States
(12) Patent Application Publication
(10) Pub. No.: US 2025/0339800 A1
(43) Pub. Date: Nov. 6, 2025

(54) AIR PRECLEANER

(71) Applicants: Shaun KNAUS, Lanigan (CA); Dean KNAUS, Lanigan (CA); Louis BRETON, Warman (CA)

(72) Inventors: Shaun KNAUS, Lanigan (CA); Dean KNAUS, Lanigan (CA); Louis BRETON, Warman (CA)

(21) Appl. No.: 18/866,478

(22) PCT Filed: May 19, 2022
(86) PCT No.: PCT/CA2022/050796

§ 371 Date: Nov. 15, 2024

(51) Int. Cl. B01D 45/14; B01D 45/16

(52) U.S. Cl. CPC B01D 45/14; B01D 45/16; B01D 2221/16

(57) ABSTRACT

An air precleaner for centrifugally separating contaminants from an air stream, the precleaner having one or more of: each fin overlapping at least 30 percent of an immediately adjacent fin; a contoured inlet surface occurring over a distance of at least 8 mm into the annular air intake passage; each of the fins backwards inclined at least 30 degrees off radial; at least two exhaust ports oriented non-perpendicular to a long axis of the outer housing; a paddle assembly comprising a rotatable portion of the inner member of the air precleaner; and a paddle assembly wherein there is at least one fewer of the connection arms than the number of the discharge paddles.

### TECHNICAL FIELD OF THE INVENTION

The present invention relates to engine intake air treatment, and more particularly to air precleaner assemblies for removing contaminants from intake air.

### BACKGROUND OF THE INVENTION

It is known in the art of engine design and operation that contaminants can negatively impact engine operation and reduce effective life. One main potential source of contaminants is air that is drawn into the engine for fuel combustion, as ambient air is known to contain such contaminants.

To prevent or at least reduce contaminant access to the engine via the engine air supply, various forms of air filtering have been proposed and are widely implemented. One such technology is an air precleaner, which in a commonly known form incorporates fins to centrifugally separate contaminants from the air stream, which contaminants may be retained within a section of the precleaner for later removal or ejected from the precleaner.

However, precleaner design is challenging in that it must balance contaminant removal efficiency with a desire to reduce airflow restriction, as a design favoring reduced restriction commonly results in poor contaminant extraction, whereas a design that has a high contaminant extraction rate commonly involves a higher airflow restriction which has negative repercussions for engine operation.

Further limitations of existing precleaner designs have been noted, such as ejected contaminants being taken up again in the incoming airstream, or airstream turbulence at the inlet negatively impacting precleaner operation.

### SUMMARY OF THE INVENTION

According to a first broad aspect of the present invention, there is provided an air precleaner for centrifugally separating contaminants from an air stream introduced into the air precleaner, the air precleaner comprising:
an outer housing;
an inner member disposed within and coaxial with the outer housing;
an inner surface of the outer housing and an outer surface of the inner member defining an annular air intake passage therebetween for receiving a contaminant-laden air stream comprising contaminants;
a plurality of static fins disposed within an upstream portion of the annular air intake passage, wherein each of the plurality of static fins overlaps at least 30 percent of an immediately adjacent fin of the plurality of static fins, the plurality of static fins configured to impart rotational direction to the contaminant-laden air stream and centrifugally separate at least some of the contaminants from the contaminant-laden air stream to form a contaminant-concentrated exhaust stream and a cleaned air stream, the inner member configured to receive the cleaned air stream and transport the cleaned air stream out of the air precleaner; and
at least one exhaust port in the outer housing to allow passage of the contaminant-concentrated exhaust stream out of the air precleaner.

In some exemplary embodiments of the first aspect, each of the plurality of static fins overlaps between 30 percent and 90 percent of an immediately adjacent fin of the plurality of static fins.

According to a second broad aspect of the present invention, there is provided an air precleaner for centrifugally separating contaminants from an air stream introduced into the air precleaner, the air precleaner comprising:
an outer housing comprising a contoured inlet surface transitioning to an inner surface of the outer housing;
an inner member disposed within and coaxial with the outer housing;
the inner surface of the outer housing and an outer surface of the inner member defining an annular air intake passage therebetween for receiving a contaminant-laden air stream comprising contaminants, the transitioning of the contoured inlet surface occurring over a distance of at least 8 mm into the annular air intake passage;
a plurality of static fins disposed within an upstream portion of the annular air intake passage, the plurality of static fins configured to impart rotational direction to the contaminant-laden air stream and centrifugally separate at least some of the contaminants from the contaminant-laden air stream to form a contaminant-concentrated exhaust stream and a cleaned air stream, the inner member configured to receive the cleaned air stream and transport the cleaned air stream out of the air precleaner; and
at least one exhaust port in the outer housing to allow passage of the contaminant-concentrated exhaust stream out of the air precleaner.

In some exemplary embodiments of the second aspect, the contoured inlet surface has an elliptical profile. In other exemplary embodiments the contoured inlet surface has a bellmouth profile. In some exemplary embodiments the transitioning of the contoured inlet surface is uninterrupted.

According to a third broad aspect of the present invention, there is provided an air precleaner for centrifugally separating contaminants from an air stream introduced into the air precleaner, the air precleaner comprising:
an outer housing;
an inner member disposed within and coaxial with the outer housing;
an inner surface of the outer housing and an outer surface of the inner member defining an annular air intake passage therebetween for receiving a contaminant-laden air stream comprising contaminants;
a plurality of static fins disposed within an upstream portion of the annular air intake passage extending between the inner surface of the outer housing and the outer surface of the inner member, each of the plurality of fins backwards inclined at least 30 degrees off radial, the plurality of static fins configured to impart rotational direction to the contaminant-laden air stream and centrifugally separate at least some of the contaminants from the contaminant-laden air stream to form a contaminant-concentrated exhaust stream and a cleaned air stream, the inner member configured to receive the cleaned air stream and transport the cleaned air stream out of the air precleaner; and
at least one exhaust port in the outer housing to allow passage of the contaminant-concentrated exhaust stream out of the air precleaner.

In some exemplary embodiments of the third aspect, each of the plurality of fins is at least partially curved and backwards inclined adjacent the outer surface of the inner member. In some exemplary embodiments, each of the plurality of fins approaches a radial orientation adjacent the inner surface of the outer housing.

According to a fourth broad aspect of the present invention, there is provided an air precleaner for centrifugally separating contaminants from an air stream introduced into the air precleaner, the air precleaner comprising:
an outer housing;
an inner member disposed within and coaxial with the outer housing;
an inner surface of the outer housing and an outer surface of the inner member defining an annular air intake passage therebetween for receiving a contaminant-laden air stream comprising contaminants;
a plurality of static fins disposed within an upstream portion of the annular air intake passage, the plurality of static fins configured to impart rotational direction to the contaminant-laden air stream and centrifugally separate at least some of the contaminants from the contaminant-laden air stream to form a contaminant-concentrated exhaust stream and a cleaned air stream, the inner member configured to receive the cleaned air stream and transport the cleaned air stream out of the air precleaner; and
at least two exhaust ports in the outer housing to allow passage of the contaminant-concentrated exhaust stream out of the air precleaner, the at least two exhaust ports oriented non-perpendicular to a long axis of the outer housing.

In some exemplary embodiments of the fourth aspect, each of the at least two exhaust ports is angled off of parallel with the long axis of the outer housing. In some exemplary embodiments, each of the at least two exhaust ports is defined by paired peripheral surfaces, the paired peripheral surfaces contoured so as to direct the contaminant-concentrated exhaust stream non-tangentially outwardly away from the air precleaner.

According to a fifth broad aspect of the present invention, there is provided an air precleaner for centrifugally separating contaminants from an air stream introduced into the air precleaner, the air precleaner comprising:
an outer housing;
an inner member disposed within and coaxial with the outer housing;
an inner surface of the outer housing and an outer surface of the inner member defining an annular air intake passage therebetween for receiving a contaminant-laden air stream comprising contaminants;
a plurality of static fins disposed within an upstream portion of the annular air intake passage, the plurality of static fins configured to impart rotational direction to the contaminant-laden air stream and centrifugally separate at least some of the contaminants from the contaminant-laden air stream to form a contaminant-concentrated exhaust stream and a cleaned air stream, the inner member configured to receive the cleaned air stream and transport the cleaned air stream out of the air precleaner;
a paddle assembly comprising:
   a rotatable member configured for rotation in response to flow of the cleaned air stream past the rotatable member;
   at least one peripheral member retaining one or more discharge paddles in a downstream portion of the annular air intake passage for directing the contaminant-concentrated exhaust stream outwardly against the inner surface of the outer housing; and
   at least one connection arm extending radially outwardly from the rotatable member to the at least one peripheral member;
   wherein there is at least one fewer of the connection arms than the number of the discharge paddles; and
at least one exhaust port in the outer housing to allow passage of the contaminant-concentrated exhaust stream out of the air precleaner.

In some exemplary embodiments, the rotatable member comprises a rotatable portion of the inner member and at least one rotor drive paddle connected to and retained at least partially within the rotatable portion, and wherein the at least one rotor drive paddle comprises at least one angled portion to aid in rotation of the at least one rotor drive paddle in response to the flow of the cleaned air stream. The at least one peripheral member may be a single paddle ring retaining all of the discharge paddles; alternatively, the at least one peripheral member may be at least two peripheral members, at least one of the at least two peripheral members retaining at least two of the discharge paddles. Some exemplary embodiments comprise at least five rotor drive paddles.

According to a sixth broad aspect of the present invention, there is provided an air precleaner for centrifugally separating contaminants from an air stream introduced into the air precleaner, the air precleaner comprising:
an outer housing;
an inner member disposed within and coaxial with the outer housing;
an inner surface of the outer housing and an outer surface of the inner member defining an annular air intake passage therebetween for receiving a contaminant-laden air stream comprising contaminants;
a plurality of static fins disposed within an upstream portion of the annular air intake passage, the plurality of static fins configured to impart rotational direction to the contaminant-laden air stream and centrifugally separate at least some of the contaminants from the contaminant-laden air stream to form a contaminant-concentrated exhaust stream and a cleaned air stream, the inner member configured to receive the cleaned air stream and transport the cleaned air stream out of the air precleaner;
a paddle assembly comprising:
   a rotatable portion of the inner member configured for rotation in response to flow of the cleaned air stream past the rotatable member;
   at least one discharge paddle retained in a downstream portion of the annular air intake passage for directing the contaminant-concentrated exhaust stream outwardly against the inner surface of the outer housing; and
   at least one connection arm extending radially outwardly from the rotatable portion to the at least one discharge paddle; and
at least one exhaust port in the outer housing to allow passage of the contaminant-concentrated exhaust stream out of the air precleaner.

Some exemplary embodiments of the sixth broad aspect further comprise at least one rotor drive paddle connected to and retained at least partially within the rotatable portion, and wherein the at least one rotor drive paddle comprises at least one angled portion to aid in rotation of the at least one rotor drive paddle in response to the flow of the cleaned air stream.

In some exemplary embodiments there is at least one fewer of the rotor drive paddles than the number of the connection arms.

In some exemplary embodiments the at least one discharge paddle is retained on a peripheral member connected to the at least one connection arm.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments according to the present invention:

FIG. 1 is a bottom perspective view of an exemplary embodiment of the present invention.

FIG. 2a is a bottom plan view of the exemplary embodiment of FIG. 1.

FIG. 2b is a top plan view of an exemplary fin assembly showing the backwards inclined angle of the fins.

FIG. 3 is an inverted bottom perspective view of an exemplary embodiment of the present invention.

FIG. 4 is a side perspective view of the exemplary embodiment of FIG. 3 partially transparent to illustrate the overlapping fins.

FIG. 5 is an inverted bottom perspective view showing a contoured inlet.

FIG. 6 is a diagram showing one example of a contoured inlet in section with exemplary measurements.

FIG. 7 is a sectional view of an exemplary embodiment through the centre on a plane parallel to the long axis.

FIG. 8 is a detailed bottom perspective view of overlapping rings showing backwards inclination.

FIG. 9 is a side elevation view of an exemplary embodiment showing exhaust ports in the outer housing.

FIG. 10 is a top perspective view showing exhaust ports in the outer housing.

FIG. 11 is a side elevation view showing exhaust ports in the outer housing.

FIG. 12 is a detailed sectional view across the exhaust ports showing their contoured profile.

FIG. 13 is a top perspective view of an exemplary paddle assembly.

FIG. 14 is a sectional view and detail view of an exemplary paddle assembly on a plane perpendicular to the long axis.

FIG. 15 is a top perspective view of an exemplary embodiment with the top portion transparent to show an exemplary paddle assembly.

FIG. 16 is an exploded view of an exemplary embodiment.

FIGS. 17a, 17b and 17c are top perspective, side perspective and plan views of a further exemplary paddle assembly.

Exemplary embodiments will now be described with reference to the accompanying drawings.

### DETAILED DESCRIPTION OF EXEMPLARY EMBODIMENTS

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present invention is directed to an air precleaner for centrifugally removing contaminants from intake air to allow a cleaner air stream to enter, for example, an engine air intake. Embodiments according to the present invention may incorporate one or more of: each fin overlapping at least 30 percent of an immediately adjacent fin; a contoured inlet surface occurring over a distance of at least 8 mm into the annular air intake passage; each of the fins backwards inclined at least 30 degrees off radial; at least two exhaust ports oriented non-perpendicular to a long axis of the outer housing; a paddle assembly comprising a rotatable portion of the inner member of the air precleaner; and a paddle assembly wherein there is at least one fewer of the connection arms than the number of the discharge paddles.

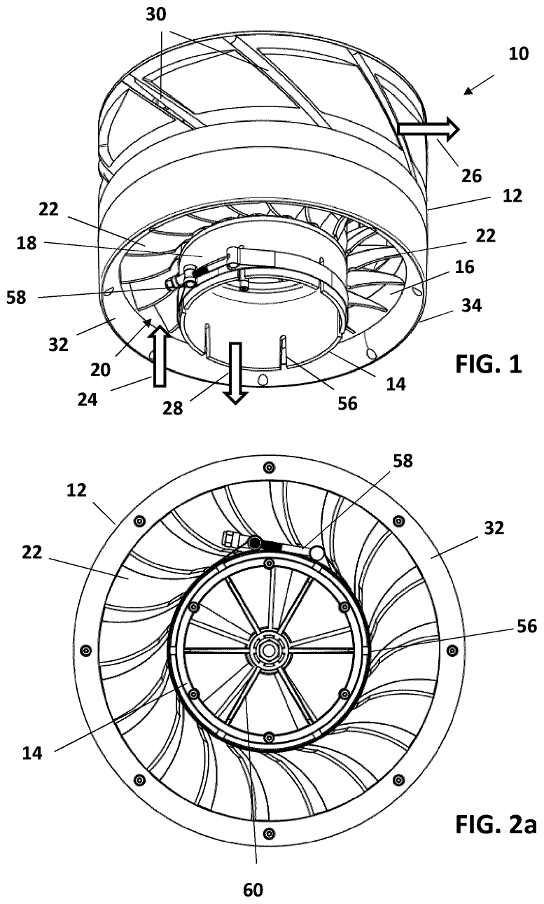

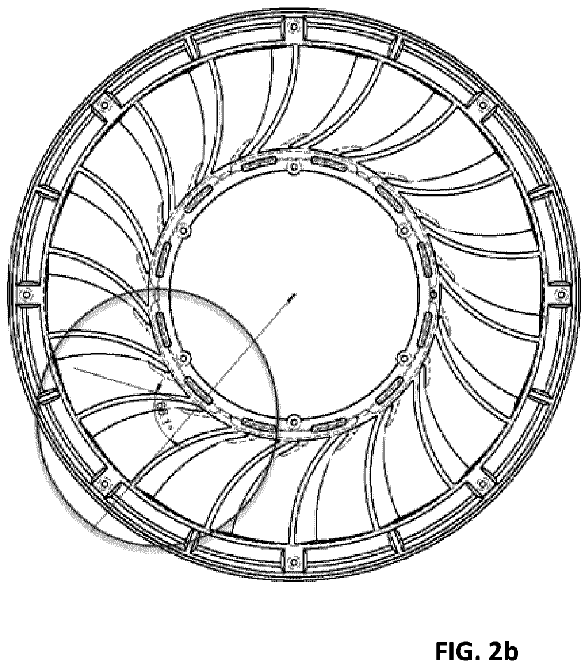

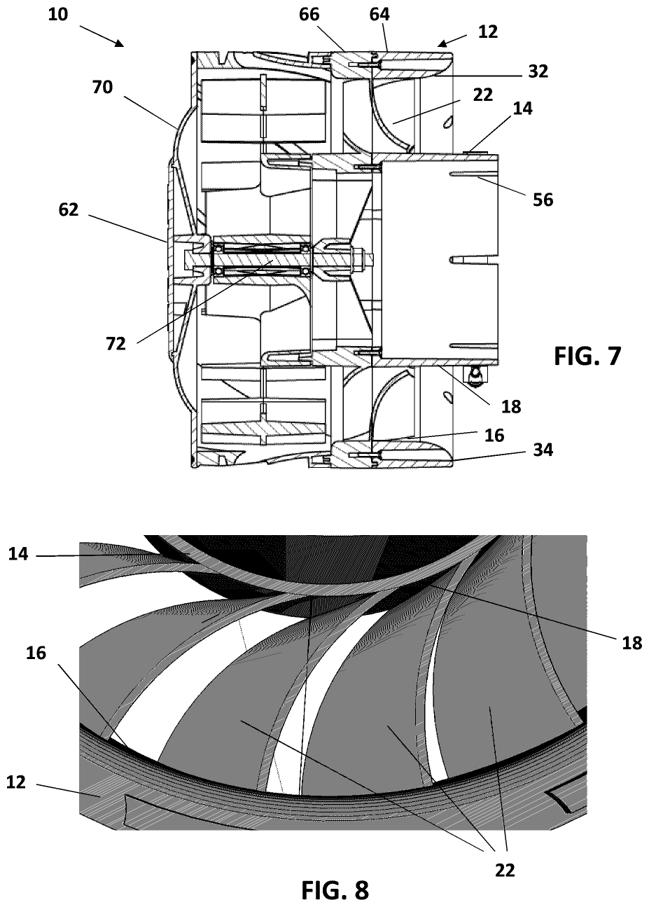

Turning now to FIG. 1 and FIG. 2, an exemplary air precleaner 10 is illustrated. The precleaner 10 comprises an outer housing 12 and an inner member 14 coaxially disposed within the outer housing 12, thereby forming an annular air intake passage 20 between an inner surface 16 of the outer housing 12 and an outer surface 18 of the inner member 14. As can best be seen in FIG. 7, the annular air intake passage 20 extends toward the top disc 70 and is in then in communication with the interior of the hollow cylindrical inner member 14. A contaminant-laden air stream 24 is drawn into the passage 20, with contaminants removed as described hereinbelow, resulting in a contaminant-concentrated exhaust stream 26 and a cleaned air stream 28. The cleaned air stream 28 is intended for introduction to, for example, an engine. The inner member 14 comprises notches 56 at an outlet end and a clamp 58, to allow the inner member 14 to be secured to an air intake of, for example, an engine. Structural support members 60 inside the inner member 14 are shown in FIG. 2.

The precleaner 10 further comprises a plurality of radially disposed fins 22 extending between the inner surface 16 and the outer surface 18. The fins 22 are static, and they may be straight or (as illustrated) curved. The fins 22 function to receive the contaminant-laden air stream 24 and impart rotation to the stream 24, so that contaminants in the air stream 24 are forced outwardly through centrifugal force toward a plurality of exhaust ports 30 in the outer housing 12 through which the contaminant-concentrated exhaust stream 26 is expelled.

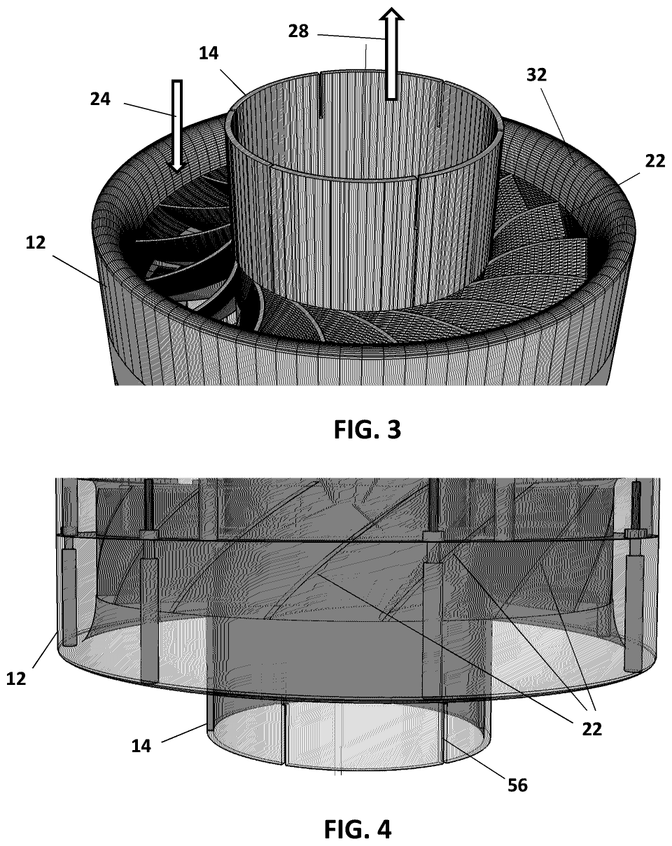

FIG. 2a to FIG. 4 illustrate various features of the exemplary fins 22, not all of which will be present in every exemplary embodiment of the present invention. Some exemplary fins are backwards inclined at least 30 degrees off radial. In some exemplary embodiments such as that illustrated in FIGS. 2a and 2b, the fins 22 are backwards inclined approximately 60 degrees off radial. It has been found that a fin design that is backwards inclined may improve contaminant removal while maintaining a desirable air restriction level, and it is believed (without being restricted to theory) that the design helps force contaminants outwardly toward the outer housing.

In some further embodiments, the backwards inclined fins (such as the fins 22 of the illustrated embodiment) may further be curved, such that the fins are backwards inclined at the inner member but transition towards perpendicular at the outer housing, as shown in FIG. 8. Again without being restricted to theory, it is believed that the transition towards perpendicular may reduce air restriction.

FIG. 4 illustrates the exemplary embodiment wherein each fin 22 overlaps an immediately adjacent fin 22, and itself is overlapped by the fin 22 on its other side. The degree of overlap is at least 30 percent, and it has been found that overlapping the fins at least 30 percent increases separation performance while reducing air restriction. Below are charts illustrating the impact of fin overlap on separation efficiency and air restriction.

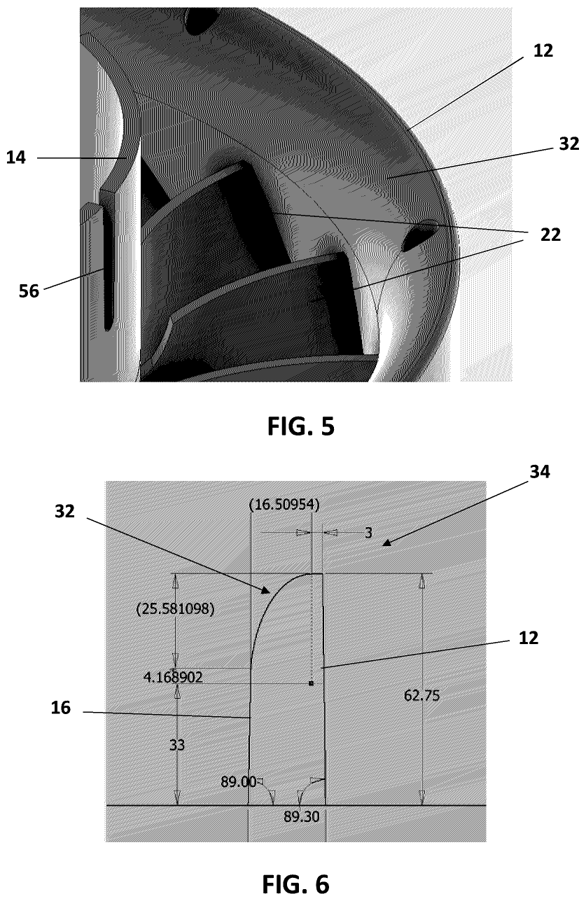

The exemplary precleaner 10 further comprises a contoured inlet surface 32 at an inlet end 34 of the outer housing 12. FIGS. 1, 2, 3 and 5 show this contoured inlet surface 32 from different angles, while FIG. 6 provides exemplary measurements (in mm and degrees) for such a contoured inlet surface 32. It has been found that air inlets of prior art precleaner assemblies are often non-contoured (flat end with straight walls) or have some structural interruption to the surface, which has been found to introduce turbulence to the incoming air stream and thus undesirably increases air restriction. It has been found that incorporating a contoured inlet surface occurring over a distance of at least 8 mm extending from the inlet end 34 into the annular air intake passage 20 can provide a smoother intake air flow that may reduce turbulence and thus provide improved air restriction. Below is a chart illustrating the impact of contouring on air restriction.

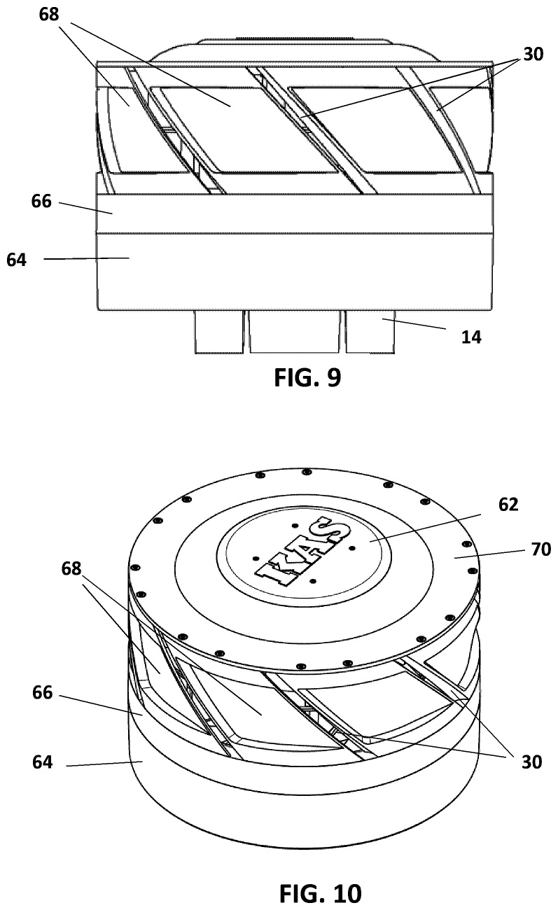

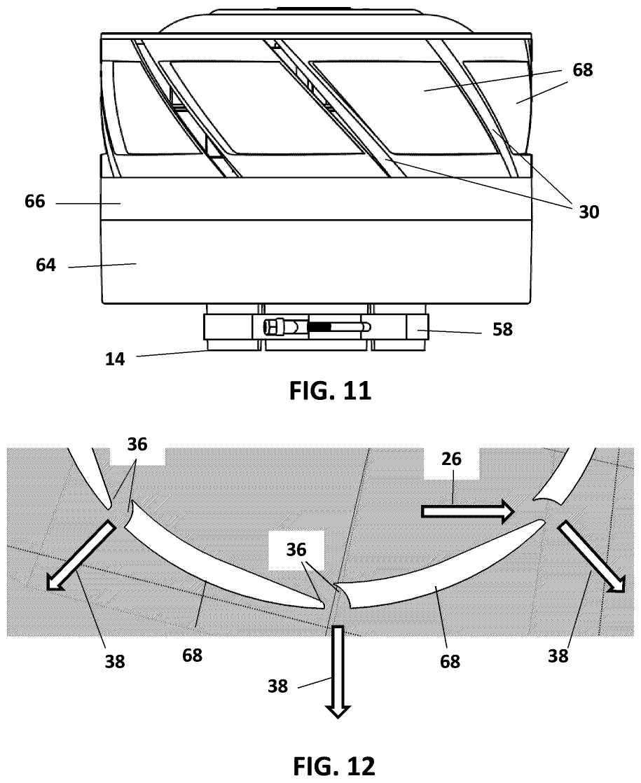

As noted hereinabove, the purpose of a precleaner is to remove contaminants to enable provision of a cleaner air stream to, for example, an engine air intake, and to that end certain precleaner assemblies such as embodiments of the present invention generate centrifugal force to move contaminants outwardly toward one or more exhaust ports in an outer housing. Turning now to FIGS. 9 to 12, an exemplary embodiment of the present invention is illustrated wherein a plurality of exhaust ports 30 are provided in the outer housing 12 to allow the ejection of the contaminant-concentrated exhaust stream 26. As can best be seen in FIG. 9, the exhaust ports 30 are oriented non-perpendicular to a long axis of the outer housing 12, and specifically in the illustrated embodiment they are disposed in an angled orientation on circumferential sides of the outer housing 12. It is possible to have other placements and orientations of the exhaust ports within the scope of the present invention. In addition to potentially improving separation efficiency and air restriction, angled exhaust ports 30 were found to desirably reduce discharge noise. Below is a chart illustrating the impact of exhaust port angles on discharge noise.

One deficiency noted in certain prior art designs is the re-intake of exhaust air, due to certain designs expelling exhaust tangential to the port and thus being ineffective in forcing the exhaust far enough away from the intake area. In certain embodiments of the present invention, this deficiency is addressed by contoured exhaust ports 30, as best shown in FIG. 12. As can be seen, each exhaust port 30 comprises paired peripheral surfaces 36, which surfaces 36 effectively redirect the contaminant-concentrated exhaust stream 26 outwardly away from the precleaner 10. While any angle greater than tangential may be beneficial, the illustrated embodiment shows a direction 38 that approaches radial and is thus most desirable.

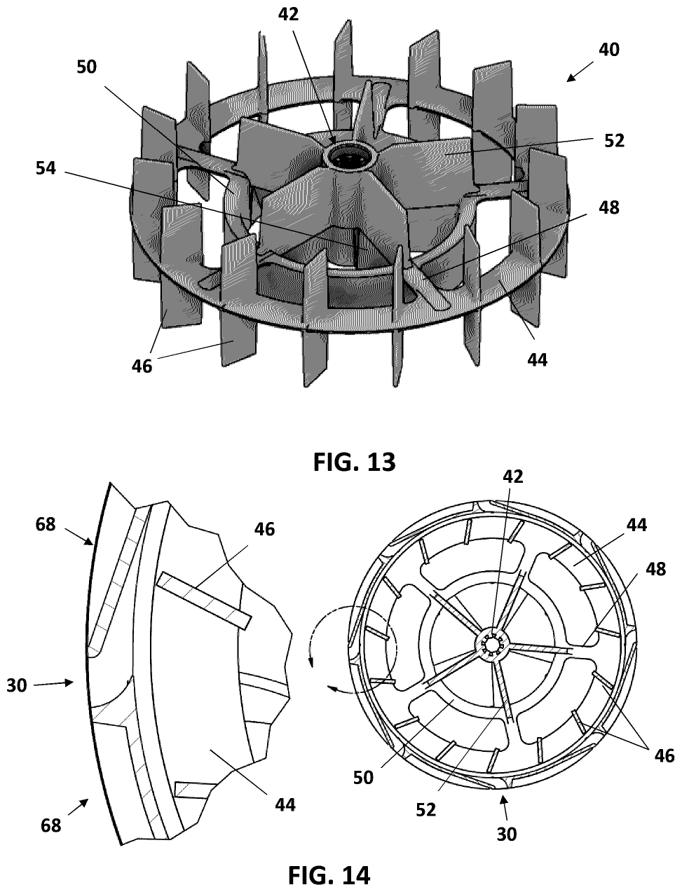

Turning now to FIGS. 13 to 16, an exemplary paddle assembly 40 for the precleaner 10 is illustrated. Discharge paddles 46 rotate within the outer housing 12 to help drive contaminants towards the exhaust ports 30. In prior art designs, each discharge paddle is connected to a central hub by a connection arm, and so as the number of discharge paddles increases there is necessarily an increased number of connection arms passing across the air flow passage, which undesirably increases air restriction as well as increasing turbulence. To address this deficiency, certain embodiments of the present invention employ one or more peripheral members, and in the illustrated embodiment a single paddle ring 44, to support the discharge paddles 46. By having at least one peripheral member support two or more discharge paddles, fewer connections arms are required. As can be seen in the illustrated embodiment, for example, using a single paddle ring 44 to support all fifteen discharge paddles 46 allows the use of only five connection arms 48, thus significantly reducing the amount of structure passing through the air passage.

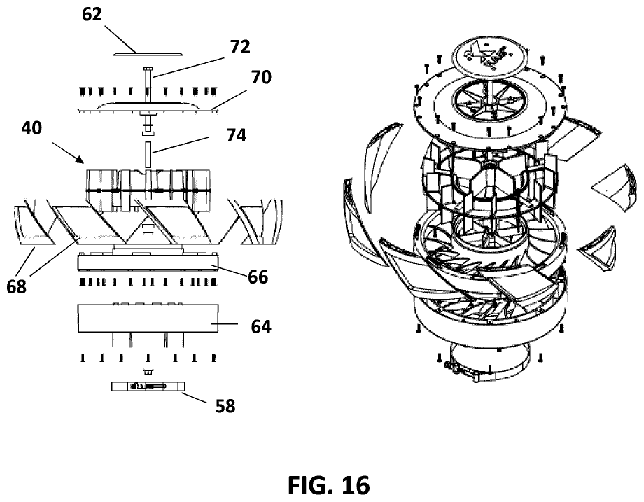

The paddle assembly 40 further comprises a means to impart rotation to the discharge paddles 46 via the connection arms 48 and the paddle ring 44, namely a rotatable member 42. As can best be seen in FIG. 13, the rotatable member 42 is centrally disposed within the precleaner 10 and comprises a rotatable portion 50 of the inner member 14 and a plurality of rotor drive paddles 52. The rotor drive paddles 52 are rotatably mounted on a shaft 72 with a bearing spacer 74 (shown in FIG. 7 and FIG. 16), where the flow of the cleaned air stream 28 engages the paddles 52 causing rotation of the rotatable member 42. The rotor drive paddles 52 comprise angled portions 54 to better capture the energy of the stream 28 to move the paddle ring 44 and discharge paddles 46. The rotor drive paddles 52 are mounted on the rotatable portion 50 of the inner member 14, and the rotation of the rotor drive paddles 52 drives rotation of the rotatable portion 50 (independently of the rest of the inner member 14, which is static). The connection arms 48 are mounted on the rotatable portion 50 and thus rotate as the rotatable portion 50 rotates, thereby imparting rotation to the paddle ring 44, which causes the discharge paddles 46 to move around the periphery of the inner passage adjacent the exhaust ports 30 and help to expel the contaminant-concentrated exhaust stream 26.

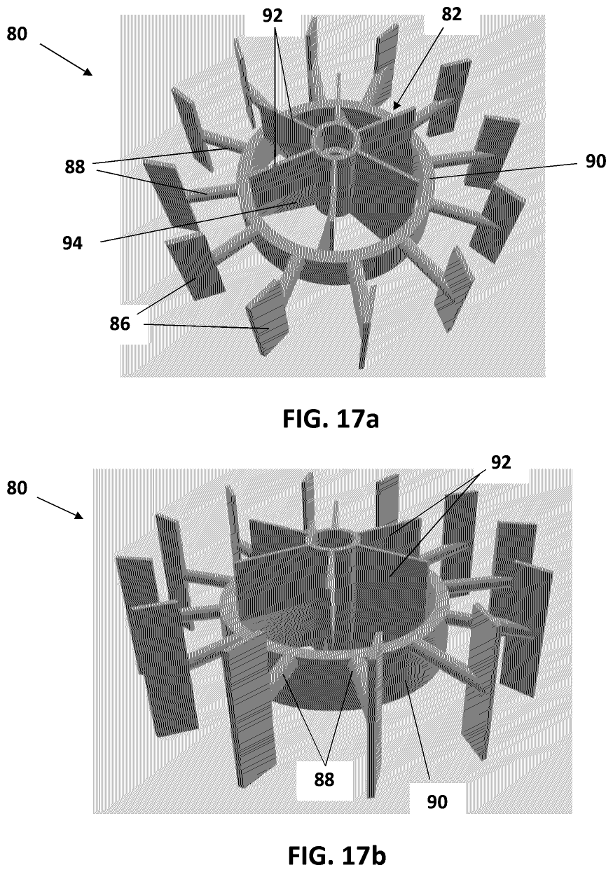

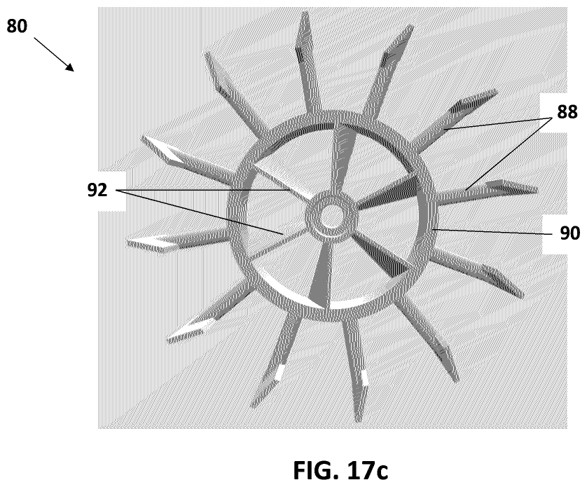

Although the embodiment shown in FIG. 13 has an equal number of rotor drive paddles 52 and connection arms 48, it is within the scope of the present invention to have different numbers. For example, as illustrated in FIGS. 17a to 17c, there can be fewer rotor drive paddles than connection members, and the paddle ring is eliminated in this embodiment. In this illustrated embodiment, a paddle assembly 80 comprises a means to impart rotation to discharge paddles 86 via connection arms 88, namely a rotatable member 82. The rotatable member 82 is centrally disposed within the precleaner and comprises a rotatable portion 90 of the inner member and a plurality of rotor drive paddles 92. The flow of the cleaned air stream engages the rotor drive paddles 92 causing rotation of the rotatable member 82. The rotor drive paddles 92 comprise angled portions 94 to better capture the energy of the stream to move the discharge paddles 86. The rotor drive paddles 92 are mounted on the rotatable portion 90 of the inner member, and the rotation of the rotor drive paddles 92 drives rotation of the rotatable portion 90 (independently of the rest of the inner member, which is static). The connection arms 88 are mounted on the rotatable portion 90 and thus rotate as the rotatable portion 90 rotates, thereby imparting rotation to the discharge paddles 86 to move around the periphery of the inner passage adjacent the exhaust ports and help to expel the contaminant-concentrated exhaust stream. In this embodiment, there are only six rotor drive paddles 92, while there are twelve connection arms 88 each connecting to a discharge paddle 86. As will be clear based on the within teaching, the discharge paddles 86 could also be retained on a paddle ring to which the connection arms 88 are connected, and thus the numbers of rotor drive paddles 92, connection arms 88 and discharge paddles 86 may differ from each other.

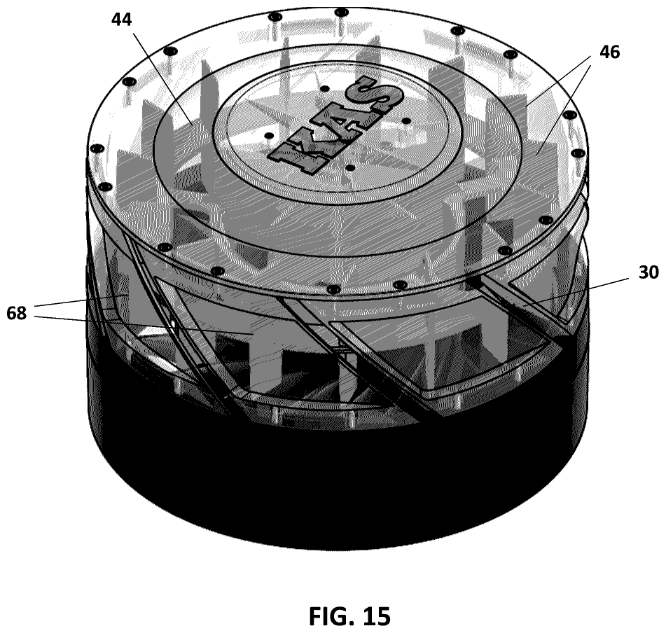

FIG. 15 in partial transparent view and FIG. 16 in exploded view illustrate certain structural details of the exemplary precleaner 10. For example, it can be seen that the outer housing 10 comprises a cover 62, the top disc 70, an upstream fin assembly 64, a downstream fin assembly 66, and exhaust area sections 68. The exhaust area sections 68 (also shown in FIGS. 7, 9, 10, 11, 12 and 14) are separate pieces that are mounted in spaced-apart orientation such that the spacing between the sections 68 are the exhaust ports 30.

The foregoing is considered as illustrative only of the principles of the present invention. The scope of the claims should not be limited by the exemplary embodiments set forth in the foregoing, but should be given the broadest interpretation consistent with the specification as a whole.

1-21. (canceled)

22. An air precleaner for centrifugally separating contaminants from an air stream introduced into the air precleaner, the air precleaner comprising:
an outer housing comprising a contoured inlet surface transitioning to an inner surface of the outer housing, the contoured inlet surface comprising an elliptical profile;
an inner member disposed within the outer housing;
an annular air intake passage between the inner surface of the outer housing and an outer surface of the inner member for receiving a contaminant-laden air stream comprising contaminants;
a plurality of static fins disposed within the annular air intake passage, the plurality of static fins configured to impart rotational direction to the contaminant-laden air stream and centrifugally separate at least some of the contaminants from the contaminant-laden air stream to form a contaminant-concentrated stream and a cleaned air stream, a cleaned air stream passage configured to receive the cleaned air stream and transport the cleaned air stream out of the air precleaner; and
means for removing the contaminant-concentrated stream out of the air precleaner.

23. The air precleaner of claim 22 wherein the inner member comprises the cleaned air stream passage.

24. The air precleaner of claim 22 wherein the inner surface of the outer housing and the outer surface of the inner member define the annular air intake passage therebetween.

25. The air precleaner of claim 22 wherein the inner member is coaxial with the outer housing.

26. The air precleaner of claim 22 wherein the contoured inlet surface transitions from an intake end of the outer housing to adjacent an upstream end of the plurality of static fins.

27. The air precleaner of claim 22 wherein the plurality of static fins is disposed within an upstream portion of the annular air intake passage.

28. An air precleaner for centrifugally separating contaminants from an air stream introduced into the air precleaner, the air precleaner comprising:
an outer housing;
an inner member disposed within the outer housing;
an annular air intake passage between an inner surface of the outer housing and an outer surface of the inner member for receiving a contaminant-laden air stream comprising contaminants;
a plurality of static fins disposed within the annular air intake passage extending between the inner surface of the outer housing and the outer surface of the inner member, a leading edge of each of the plurality of static fins curved along at least a portion thereof between the inner surface of the outer housing and the outer surface of the inner member, the plurality of static fins configured to impart rotational direction to the contaminant-laden air stream and centrifugally separate at least some of the contaminants from the contaminant-laden air stream to form a contaminant-concentrated stream and a cleaned air stream, a cleaned air stream passage configured to receive the cleaned air stream and transport the cleaned air stream out of the air precleaner; and
means for removing the contaminant-concentrated stream out of the air precleaner.

29. The air precleaner of claim 8 wherein each of the plurality of fins is backwards inclined off of radial from a long axis of the air precleaner.

30. The air precleaner of claim 8 wherein each of the plurality of fins approaches a radial orientation adjacent the inner surface of the outer housing.

31. The air precleaner of claim 8 wherein the inner member is coaxial with the outer housing.

32. The air precleaner of claim 8 wherein the inner member comprises the cleaned air stream passage.

33. The air precleaner of claim 8 wherein the inner surface of the outer housing and the outer surface of the inner member define the annular air intake passage therebetween.

34. The air precleaner of claim 8 wherein the plurality of static fins is disposed within an upstream portion of the annular air intake passage.

35. An air precleaner for centrifugally separating contaminants from an air stream introduced into the air precleaner, the air precleaner comprising:
an outer housing;
an inner member disposed within the outer housing;
an annular air intake passage between an inner surface of the outer housing and an outer surface of the inner member for receiving a contaminant-laden air stream comprising contaminants;
a plurality of static fins disposed within the annular air intake passage, the plurality of static fins configured to impart rotational direction to the contaminant-laden air stream and centrifugally separate at least some of the contaminants from the contaminant-laden air stream to form a contaminant-concentrated stream and a cleaned air stream, a cleaned air stream passage configured to receive the cleaned air stream and transport the cleaned air stream out of the air precleaner; and
at least one port in the outer housing to allow passage of the contaminant-concentrated stream out of the air precleaner, the at least one port angled off of parallel with a long axis of the outer housing.

36. The air precleaner of claim 35 wherein the inner member is coaxial with the outer housing.

37. The air precleaner of claim 35 wherein the inner surface of the outer housing and the outer surface of the inner member define the annular air intake passage therebetween.

38. The air precleaner of claim 35 wherein the inner member comprises the cleaned air stream passage.

39. The air precleaner of claim 35 wherein the plurality of static fins is disposed within an upstream portion of the annular air intake passage.

40. The air precleaner of claim 35 wherein each port is defined by at least one peripheral surface, the at least one peripheral surface contoured so as to direct the contaminant-concentrated stream non-tangentially outwardly away from the air precleaner.

41. An air precleaner for centrifugally separating contaminants from an air stream introduced into the air precleaner, the air precleaner comprising:
an outer housing;
an inner member disposed within the outer housing;
an annular air intake passage between an inner surface of the outer housing and an outer surface of the inner member for receiving a contaminant-laden air stream comprising contaminants;
a plurality of static fins disposed within the annular air intake passage, the plurality of static fins configured to impart rotational direction to the contaminant-laden air stream and centrifugally separate at least some of the contaminants from the contaminant-laden air stream to form a contaminant-concentrated stream and a cleaned air stream, a cleaned air stream passage configured to receive the cleaned air stream and transport the cleaned air stream out of the air precleaner;
a paddle assembly comprising:
a rotatable member configured for rotation;
at least one peripheral member retaining one or more discharge paddles in a downstream portion of the annular air intake passage for directing the contaminant-concentrated stream outwardly against the inner surface of the outer housing; and
at least one connection arm extending radially outwardly from the rotatable member to the at least one peripheral member;
wherein there is at least one fewer of the connection arms than the number of the discharge paddles; and
means to allow passage of the contaminant-concentrated stream out of the air precleaner.

42. The air precleaner of claim 41 wherein the inner member is coaxial with the outer housing.

43. The air precleaner of claim 41 wherein the inner surface of the outer housing and the outer surface of the inner member define the annular air intake passage therebetween.

44. The air precleaner of claim 41 wherein the inner member comprises the cleaned air stream passage.

45. The air precleaner of claim 41 wherein the plurality of static fins is disposed within an upstream portion of the annular air intake passage.

46. The air precleaner of claim 41 wherein the rotatable member comprises a rotatable portion of the inner member and at least one rotor drive paddle connected to and retained at least partially within the rotatable portion.

47. The air precleaner of claim 46 wherein there are a different number of the at least one rotor drive paddle than the discharge paddles.

48. The air precleaner of claim 41 wherein the at least one peripheral member is a single paddle ring retaining all of the discharge paddles.

49. The air precleaner of claim 41 wherein the rotatable member is configured for rotation in response to flow of the cleaned air stream past the rotatable member.

50. An air precleaner for centrifugally separating contaminants from an air stream introduced into the air precleaner, the air precleaner comprising:
an outer housing;
an inner member disposed within the outer housing;
an annular air intake passage between an inner surface of the outer housing and an outer surface of the inner member for receiving a contaminant-laden air stream comprising contaminants;
a plurality of static fins disposed within the annular air intake passage, the plurality of static fins configured to impart rotational direction to the contaminant-laden air stream and centrifugally separate at least some of the contaminants from the contaminant-laden air stream to form a contaminant-concentrated stream and a cleaned air stream, a cleaned air stream passage configured to receive the cleaned air stream and transport the cleaned air stream out of the air precleaner;
a paddle assembly comprising:
a rotatable portion of the inner member configured for rotation;
at least one discharge paddle retained in a downstream portion of the annular air intake passage for directing the contaminant-concentrated stream outwardly against the inner surface of the outer housing; and
at least one connection arm extending radially outwardly from the rotatable portion to the at least one discharge paddle.

51. The air precleaner of claim 50 further comprising at least one rotor drive paddle connected to and retained at least partially within the rotatable portion, and wherein the at least one rotor drive paddle comprises at least one angled portion to aid in rotation of the at least one rotor drive paddle in response to the flow of the cleaned air stream.

52. The air precleaner of claim 51 wherein the at least one discharge paddle comprises at least two discharge paddles, and there is at least one fewer of the at least one rotor drive paddle than the number of the at least two discharge paddles.

53. The air precleaner of claim 50 wherein the inner member is coaxial with the outer housing.

54. The air precleaner of claim 50 wherein the inner surface of the outer housing and the outer surface of the inner member define the annular air intake passage therebetween.

55. The air precleaner of claim 50 wherein the inner member comprises the cleaned air stream passage.

56. The air precleaner of claim 50 wherein the rotatable portion of the inner member is configured for rotation in response to flow of the cleaned air stream past the rotatable member.

57. The air precleaner of claim 50 wherein the plurality of static fins is disposed within an upstream portion of the annular air intake passage.

58. An air precleaner for centrifugally separating contaminants from an air stream introduced into the air precleaner, the air precleaner comprising:
an outer housing;
an inner member disposed within the outer housing;
an annular air intake passage with an elliptical leading edge between an inner surface of the outer housing and an outer surface of the inner member for receiving a contaminant-laden air stream comprising contaminants;
a plurality of static fins disposed within the annular air intake passage, the plurality of static fins configured with an backward inclined curved leading edge to impart rotational direction to the contaminant laden air stream and centrifugally separate at least some of the contaminants from the contaminant-laden air stream to form a contaminant-concentrated stream and a cleaned air stream, a cleaned air stream passage configured to receive the cleaned air stream and transport the cleaned air stream out of the air precleaner;
a paddle assembly comprising:
a rotatable portion of the inner member configured for rotation;
at least one rotor drive paddle connected to and retained at least partially within the rotatable portion, and wherein the at least one rotor drive paddle comprises at least one angled portion to aid in rotation of the rotatable portion in response to the flow of the cleaned air stream;
at least one peripheral member retaining at least two discharge paddles in a downstream portion of the annular air intake passage for directing the contaminant-concentrated stream outwardly against the inner surface of the outer housing; and
at least one connection arm extending radially outwardly from the rotatable portion to the at least one peripheral member;
the at least two discharge paddles being greater in number than each of the at least one connection arm and the at least one rotor drive paddle; and
at least one angled port in the outer housing to allow passage of the contaminant-concentrated stream out of the air precleaner;
the at least one angled port comprising a peripheral surface contoured so as to direct the contaminant-concentrated stream non-tangentially outwardly away from the air precleaner.

59. The air precleaner of claim 58 wherein the inner member is coaxial with the outer housing.

60. The air precleaner of claim 58 wherein the inner surface of the outer housing and the outer surface of the inner member define the annular air intake passage therebetween.

61. The air precleaner of claim 58 wherein the inner member comprises the cleaned air stream passage.

62. The air precleaner of claim 58 wherein the rotatable portion of the inner member is configured for rotation in response to flow of the cleaned air stream past the rotatable member.

63. The air precleaner of claim 58 wherein the plurality of static fins is disposed within an upstream portion of the annular air intake passage.
